(19) United States
(12) Patent Application Publication
(10) Pub. No.: US 2014/0095507 A1
(43) Pub. Date: Apr. 3, 2014

(54) LIBRARY APPARATUS

(71) Applicant: NEC Corporation, Tokyo (JP)

(72) Inventors: MAKOTO NAKAJIMA, Tokyo (JP); HAJIME NONAKA, Tokyo (JP); MUNEYUKI YOSHIKAWA, Tokyo (JP); KUNITAKA NEGISHI, Tokyo (JP)

(73) Assignee: NEC Corporation, Tokyo (JP)

(21) Appl. No.: 14/039,609

(22) Filed: Sep. 27, 2013

(30) Foreign Application Priority Data
Sep. 28, 2012 (JP) 2012-215355

(51) Int. Cl. G06F 17/30

(52) U.S. Cl. CPC G06F 17/30598
USPC 707/737

(57) ABSTRACT

A library apparatus according to an aspect of the present invention includes a plurality of magazines each including medium slots in which corresponding removable storage media are stored, and a magazine ID for identifying itself; at least one magazine slot each of which, at a time when one of the magazines has been loaded into itself, allocates physical slot numbers to the magazine; an ID reading unit; a logical library configuration information table including magazine presence or absence information which indicates whether or not any of the magazines is loaded in each of the at least one magazine slot; and a logical library management unit which updates the magazine presence or absence information on the basis of information indicating which of the at least one magazine slot the relevant magazine has been loaded into, and the magazine ID of the relevant magazine.

This application is based upon and claims the benefit of priority from Japanese Patent Application No. 2012-215355, filed on Sep. 28, 2012, the disclosure of which is incorporated herein in its entirety by reference.

### TECHNICAL FIELD

The present invention relates to a library apparatus.

### BACKGROUND ART

With the increase of the volume of data to be dealt with and the increase of the capacity of a storage device in a computer system of these years, a reduction of the operational administrative cost of a computer system has been conducted by means of, for example, the integration of and the uniform management of a plurality of external storage apparatuses which have been individually connected to server apparatuses and have been separately managed.

Further, as a large-capacity external storage apparatus therefor, sometimes, there is used a library apparatus which is provided with a plurality of removable storage media, a recording and retrieving apparatus for recording data into the removable storage media and retrieving data recorded in the removable storage media, and a medium transportation machinery for transporting a removable storage medium to the recording and retrieving apparatus to load the removable storage medium thereinto.

In the case where the above-described library apparatus is shared by a plurality of servers, all removable storage media used by the library apparatus are accessible to each of the servers. In Japanese Unexamined Patent Application Publication No. 2004-5381, there is disclosed a technology for, in order to prevent the occurrence of malfunctions due to access competition along with such sharing, logically partitioning a library apparatus in advance, and allowing the library apparatus to look like a plurality of independent library apparatuses (hereinafter, this technology being also referred to as a “partitioning technology”, and each of the plurality of independent library apparatuses being also referred to as a “logical library”).

In Japanese Unexamined Patent Application Publication No. 2004-5381, there is disclosed a system which is provided with a plurality of removable storage medium slots each containing a removable storage medium, a recording and retrieving apparatus for the removable storage media, and virtual controllers which perform control of movements of the removable storage media to/from the removable storage medium slots, and which are allocated mutually different logical element names. This system realizes sharing by a plurality of servers by allocating the mutually different logical element names, which are allocated to the respective virtual controllers described above, to a respective plurality of logical libraries.

In the system, it is necessary to perform partitioning control such as re-partitioning of the logical libraries, and it becomes also necessary to make any notification to the host apparatus, and perform any restarting operation.

In addition, in Japanese Unexamined Patent Application Publication No. 2011-065466, Japanese Unexamined Patent Application Publication No. Hei 06-251485 and Japanese Unexamined Patent Application Publication No. Hei 10-254640, various technologies related to a library apparatus are disclosed.

In Japanese Unexamined Patent Application Publication No. 2011-065466, there is disclosed a technology which enables a library apparatus to perform operation by means of a reading/writing method similar to that for an external storage apparatus using a general hard disk drive (HDD) device.

In Japanese Unexamined Patent Application Publication No. Hei 06-251485, there is disclosed a technology which enables the improvement of performance of a library apparatus by providing a plurality of medium transportation machineries.

In Japanese Unexamined Patent Application Publication No. Hei 10-254640, there is disclosed a technology which enables of the improvement of availability of a library apparatus by providing a removable storage medium array.

### SUMMARY

An example of an object of the present invention is to solve the aforementioned problem, that is, the occurrence of malfunctions due to access competition along with sharing, and make it possible to control the number of logical slots allocated to each of logical libraries.

A library apparatus according to an aspect of the present invention includes: a plurality of magazines, each magazine including at least one medium slot in each of which a removable storage medium is stored, and a magazine ID portion which indicates a magazine ID which is information for identifying itself; at least one magazine slot, each magazine slot being allocated at least one physical slot number which, at a time when one of the magazines has been loaded into the each magazine slot, is allocated to the at least one medium slot of the relevant magazine on a one-to-one correspondence basis; an ID reading unit configured to read a magazine ID which is indicated by the magazine ID portion of one of the magazines which has been loaded into one of the at least one magazine slot; a logical library configuration information table including at least one logical library ID each being information for identifying one of at least one logical library which is logically partitioned, at least one logical slot number each indicating a number of a corresponding one of at least one logical slot included in each of the at least one logical library, the at least one physical slot number which is allocated to each of the at least one magazine slot, and which corresponds to the at least one logical slot number, the magazine ID which is indicated by the magazine ID portion provided in a certain one of the magazines, which is to be loaded in one of the at least one magazine slot, and magazine presence or absence information which indicates whether any one of the magazines is loaded, or not, for each of the at least one magazine slot; and a logical library management unit configured to, when having detected an event in which one of the magazines has been loaded into one of the at least one magazine slot, update the magazine presence or absence information included in the logical library configuration information table, on the basis of information indicating the magazine slot into which the relevant magazine has been loaded, and the magazine ID which corresponds to the relevant magazine, and which has been read by the ID reading unit.

A library apparatus according to another aspect of the present invention includes: a plurality of magazines, each magazine including at least one medium slot in each of which a removable storage medium is stored, and a magazine ID portion which indicates a magazine ID which is information for identifying itself; at least one magazine slot, each magazine slot being allocated at least one physical slot number which, at a time when one of the magazines has been loaded into the each magazine slot, is allocated to the at least one medium slot of the relevant magazine on a one-to-one correspondence basis; an ID reading unit configured to read a magazine ID which is indicated by the magazine ID portion of one of the magazines which has been loaded into one of the at least one magazine slot; a logical library configuration information table including at least one logical library ID each being information for identifying one of at least one logical library which is logically partitioned, at least one logical slot number each indicating a number of a corresponding one of at least one logical slot included in each of the at least one logical library, the at least one physical slot number which is allocated to each of the at least one magazine slot, and which corresponds to the at least one logical slot number, and the magazine ID which is indicated by the magazine ID portion provided in a certain one of the magazines, which is loaded in one of the at least one magazine slot; and a logical library management unit configured to, when having detected an event in which one of the magazines has been loaded into one of the at least one magazine slot, update the at least one physical slot number of the logical library configuration information table into a number the same as the at least one physical slot number being allocated to the at least one medium slot of the relevant medium, on the basis of information indicating the magazine slot into which the relevant magazine has been loaded, and the magazine ID which corresponds to the relevant magazine, and which has been read by the ID reading unit.

A library apparatus according to another aspect of the present invention includes: a plurality of magazines, each magazine including at least one medium slot in each of which a removable storage medium is stored, and a partition information unit which stores therein a logical library ID being information for identifying a certain one of at least one logical library which is logically partitioned, and at least one logical slot number each indicating a number of a corresponding one of at least one logical slot included in the certain one of at least one logical library; at least one magazine slot, each magazine slot being allocated at least one physical slot number which, at a time when one of the magazines has been loaded into one of the at least one magazine slot, is allocated to the at least one medium slot of the relevant magazine on a one-to-one correspondence basis; a partition information reading and writing unit configured to access the partition information unit of the one of the magazines which has been loaded into the one of the at least one magazine slot; a logical library configuration information table including the at least one logical library ID, the at least one logical slot number, and the at least one physical slot number which is allocated to each of the at least one magazine slot, and which corresponds to the at least one logical slot number; and a logical library management unit configured to, when having detected an event in which one of the magazines has been loaded into one of the magazine slots, update each of the at least one physical slot number included in the logical library configuration information table into a number the same as a corresponding one of the at least one physical slot number being allocated to the at least one medium slot of the relevant magazine, on the basis of the logical library ID and the at least one logical slot number, which correspond to the at least one medium slot of the relevant magazine, and which have been acquired by the partition information reading and writing unit.

### BRIEF DESCRIPTION OF THE DRAWINGS

Exemplary features and advantages of the present invention will become apparent from the following detailed description when taken with the accompanying drawings in which:

FIG. 1 is a block diagram illustrating a library apparatus according to a first exemplary embodiment of the present invention.

FIG. 2 is a block diagram illustrating a configuration of a magazine, in the first exemplary embodiment of the present invention.

FIG. 3 is diagram illustrating an example of a logical library configuration information table included in a logical library configuration information table unit, in the first exemplary embodiment of the present invention.

FIG. 4 is a flowchart illustrating operation at a time of loading of a magazine, in the first exemplary embodiment of the present invention.

FIG. 5 is a flowchart illustrating operation at a time of unloading of a magazine, in the first exemplary embodiment of the present invention.

FIG. 6 is a diagram illustrating an example of a logical library configuration information table included in a logical library configuration information table unit, in a second exemplary embodiment of the present invention.

FIG. 7 is a flowchart illustrating operation at a time of loading of a magazine, in the second exemplary embodiment of the present invention.

FIG. 8 is a flowchart illustrating operation at a time of unloading of a magazine, in the second exemplary embodiment of the present invention.

FIG. 9 is a block diagram illustrating a library apparatus according to a third exemplary embodiment of the present invention.

FIG. 10 is a block diagram illustrating a configuration of a magazine in the third exemplary embodiment of the present invention.

FIG. 11 is a diagram illustrating an example of a partition information table included in a partition information unit, in the third exemplary embodiment of the present invention.

FIG. 12 is a diagram illustrating an example of a logical library configuration information table included in a logical library configuration information table unit, in the third exemplary embodiment of the present invention.

FIG. 13 is a flowchart illustrating operation at a time of loading of a magazine, in the third exemplary embodiment of the present invention.

FIG. 14 is a flowchart illustrating operation at a time of unloading of a magazine, in the third exemplary embodiment of the present invention.

FIG. 15 is a diagram illustrating an example of a logical library configuration information table included in a logical library configuration information table unit, in a fourth exemplary embodiment of the present invention.

### EXEMPLARY EMBODIMENT

Next, exemplary embodiments of the present invention will be described with reference to the drawings.

### First Exemplary Embodiment

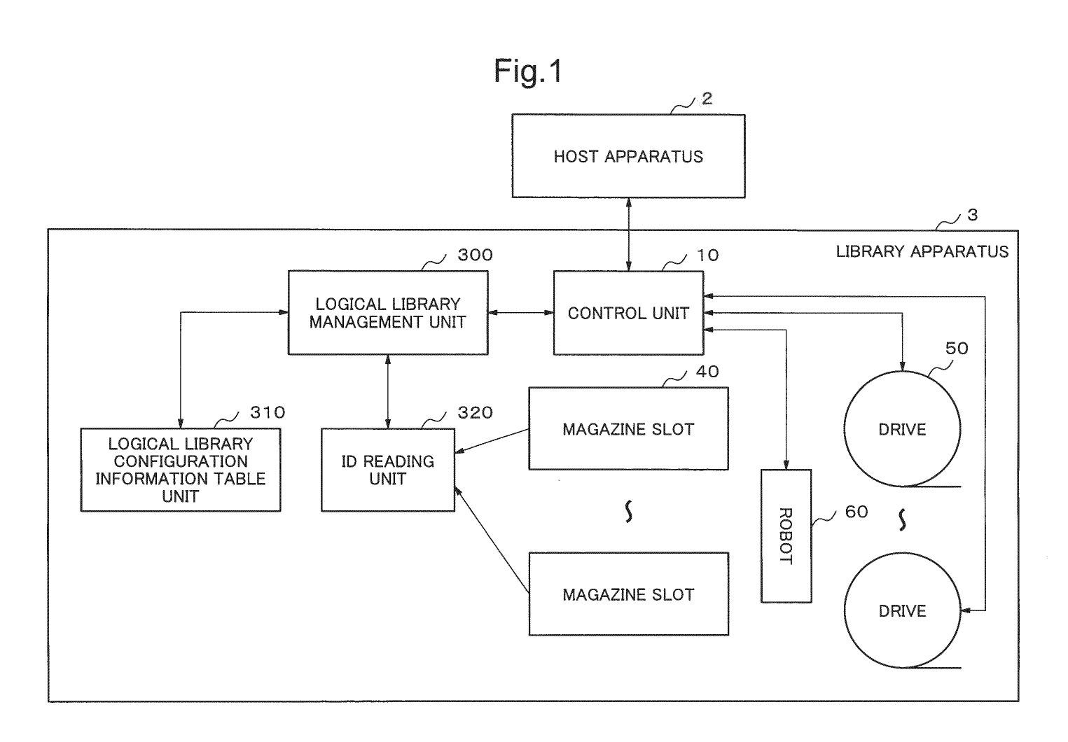

FIG. 1 is a block diagram illustrating a library apparatus according to a first exemplary embodiment of the present invention.

Referring to FIG. 1, a library apparatus 3 according to this exemplary embodiment is configured so as to be connected to a host apparatus 2 which utilizes this library apparatus 3.

The library apparatus 3 includes a control unit 10, one or more magazine slots 40, a robot 60, one or more drives 50, a logical library management unit 300, a logical library configuration information table unit 310 and an ID reading unit 320.

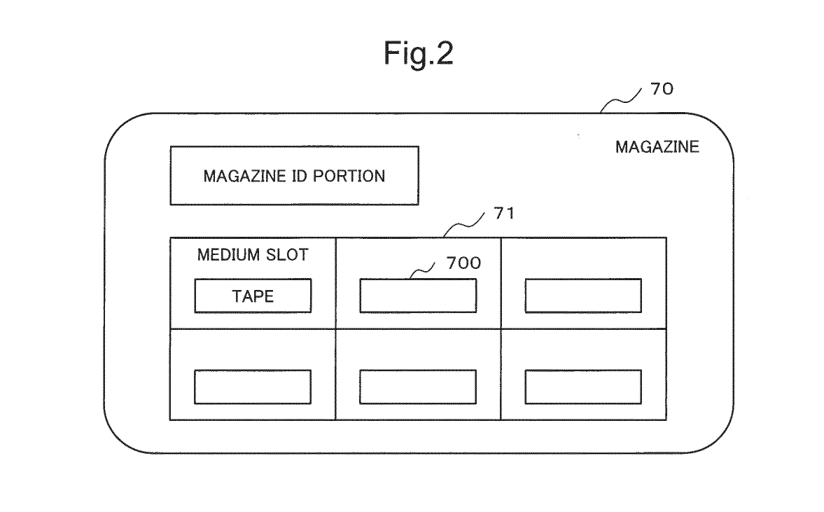

Next, a configuration of a magazine 70, which is loaded in one of the magazine slots 40 described above, is illustrated in FIG. 2.

Referring to FIG. 2, the magazine 70 includes one or more medium slots 71, a removable storage medium 700 which is stored in each of the one or more medium slots 71, and a magazine ID portion. The magazine ID portion indicates a magazine ID which is a piece of identification information for identifying the magazine 70 itself. The magazine 70 is loaded into one of the magazine slots 40 of the library apparatus 3 or is unloaded from one of the magazine slots 40 thereof, in accordance with necessity.

In addition, in this exemplary embodiment, it is supposed that the removable storage medium 700 is a tape cartridge, the number of the magazines 70 is four, and the number of the medium slots 71 of each of the magazines 70 is six. Moreover, it is supposed that the number of the magazine slots 40 is two. Further, in this exemplary embodiment, it is supposed that four magazines 70 build two logical libraries. In following description, for convenience, the two magazine slots 40 will be referred to as magazine slots 40-1 and 40-2.

Further, six physical slot numbers, which correspond to the respective six medium slots 71 of the magazine 70 to be loaded, are allocated to each of the two magazine slots 40-1 and 40-2. Six physical slot numbers #0 (zero) to #5 are allocated to the magazine slot 40-1, and six physical slot numbers #6 to #11 are allocated to the magazine slot 40-2.

When one of the magazines 70 has been loaded into any one of the magazine slots 40-1 and 40-2, numbers the same as the six physical slot numbers allocated to the any one of the magazine slots 40-1 and 40-2 are allocated to the six medium slots 71 of the loaded magazine 70 on a one-to-one correspondence basis. That is, the numbers #0 (zero) to #5 are allocated to the respective six medium slots 71 of the magazine 70 having been loaded into the magazine slot 40-1. Further, the numbers #6 to #11 are allocated to the respective six medium slots 71 of the magazine 70 having been loaded into the magazine slot 40-2.

This allocation described above makes it possible, for example, to, in order to access any one of tape cartridges which are stored in the respective medium slots 71 of one of the magazines 70 which has been loaded into the magazine slot 40-1, merely specify a corresponding one of #0 (zero) to #5 as a physical slot number.

The drive 50 performs reading of data retained in the removable storage medium 700, and performs writing of data into the removable storage medium 700.

The robot 60 is a medium transportation machinery which takes out one of the removable storage media 700 stored in the magazine 70 which is loaded in one of the magazine slots 40, transports it to a specified one of the drives 50, and mounts the removable storage medium 700 into the drive 50.

When having received an instruction for accessing a logical library from the host apparatus 2, the control unit 10 acquires a physical slot number corresponding thereto from the logical library management unit 300, and instructs the robot 60 to transport a corresponding one of the removable storage media 700 to one of the drives 50. Subsequently, with respect to the removable storage medium 700 having been mounted into the drive 50, a data writing operation or a data reading operation is performed.

Upon reception of an instruction from the logical library management unit 300, the ID reading unit 320 reads a magazine ID which is indicated by the magazine ID portion provided in the magazine 70 having been loaded into one of the magazine slots 40, and sends it to the logical library management unit 300.

In addition, the magazine ID portion may be realized by printing a bar code of a magazine ID on the magazine 70 or using a non-contact memory storing a magazine ID therein, but a method for realizing the magazine ID portion is not necessarily limited to these methods. Further, in accordance with the method for realizing the magazine ID portion, the ID reading unit 320 should employ a reading machinery suitable therefor.

The logical library configuration information table unit 310 retains configuration information related to logical libraries which are built in the library apparatus 3. This configuration information related to the logical libraries is used by the logical library management unit 300.

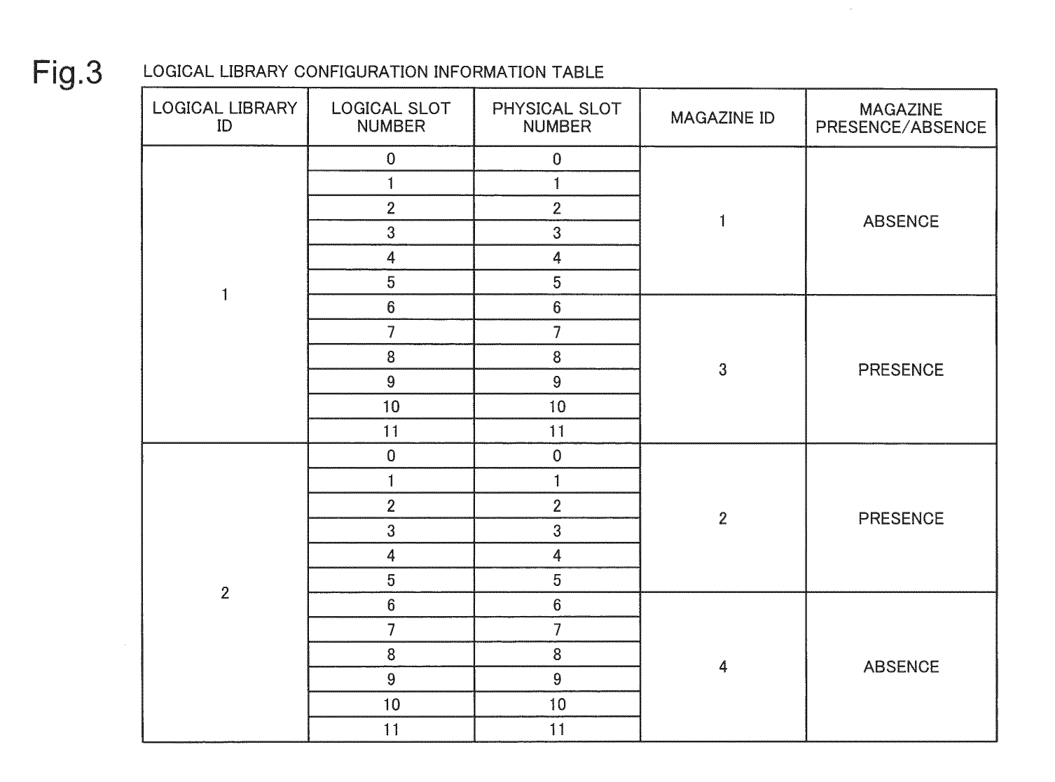

An example of a logical library configuration information table included in the logical library configuration information table unit 310 is illustrated in FIG. 3. In FIG. 3, a first line indicates item names, and second and subsequent lines indicate an example of pieces of data corresponding to each of the item names.

Referring to FIG. 3, the logical library configuration information table includes logical library ID fields, logical slot number fields, physical slot number fields, magazine ID fields and magazine presence or absence fields. The logical library ID fields each indicate an identification number of a corresponding one of logical libraries which are built by the library apparatus 3. The logical slot number fields each indicate a number of a corresponding one of logical slots included in one of the logical libraries identified by corresponding numbers of the logical library ID fields. The physical slot number fields each indicate a number of a corresponding one of physical slots which are allocated to each of the magazine slots 40, and which correspond to the respective logical slot numbers. That is, the physical slot number fields each indicate a number indicating a corresponding one of the removable storage media 700 stored in the respective medium slots 71 of one of the magazines 70 which has been loaded into one of the magazine slots 40. The magazine ID fields each indicate a magazine ID indicated by the magazine ID portion of one of the magazines 70 which is loaded in one of the magazine slots 40. The magazine presence or absence fields each indicate whether a corresponding one of the magazines 70, which have the magazine IDs indicated by the respective magazine ID fields, is loaded, or not. That is, in the magazine presence or absence field, the “presence” means that the magazine 70 having the magazine ID indicated by the magazine ID field corresponding to “presence” is in a loaded state, and the “absence” means that the magazine 70 having the magazine ID indicated by the magazine ID field corresponding to “absence” is in an unloaded state.

In addition, numerical values included in the fields of the logical library configuration information table, except for values included in the magazine presence of absence fields, are reviewed at any time, such as in a system maintenance operation, and any numerical value which is necessary to be updated is updated.

When referring to second and subsequent lines of FIG. 3, a logical library indicated by a logical library ID “1” is composed of twelve logical slots which are indicated by respective logical slot numbers #0 to #11. Physical slots corresponding to respective logical slot numbers #0 to #5 among the twelve logical slots are physical slots having respective physical slot numbers #0 to #5. Further, it can be understood that a magazine which is indicated by these physical slots numbers, and which is to be loaded into the magazine slot 40-1 is a magazine indicated by a magazine ID “1”. Moreover, it can be understood that, in the logical library configuration information table of FIG. 3, since the magazine presence or absence field corresponding to the magazine having the magazine ID “1” is “absence”, the relevant magazine is not loaded in the magazine slot 40-1.

Further, a logical library indicated by a logical library ID “2” is also composed of twelve logical slots which are indicated by respective logical slot numbers #0 to #11. It can be understood that a magazine corresponding to logical slots having respective logical slot numbers #0 to #5 among the twelve logical slots (that is, a magazine indicated by a magazine ID “2”) is loaded in the magazine slot 40-1. This is because, in the logical library configuration information table of FIG. 3, the magazine presence or absence field corresponding to the magazine having the magazine ID “2” is “presence”.

It is to be noted, here, that, in the logical library configuration information table shown in FIG. 3, each of the two magazines corresponding to the respective magazine IDs “1” and “2” can be loaded into only the magazine slot 40-1 which is allocated the physical slot numbers #0 to #5. Similarly, each of two magazines corresponding to respective magazine IDs “3” and “4” can be loaded into only the magazine slot 40-2.

When, contrary to the above-described manner, for example, any one of the magazines having the respective magazine IDs “1” and “2” has been erroneously loaded into the magazine slot 40-2, physical slot numbers allocated to the relevant magazine are changed to the physical slot numbers #6 and #11. As a result, the physical slot numbers become different from respective numbers “0” to “5” written in the physical slot number field of the logical library configuration information table of FIG. 3, and thus, the magazine presence or absence field remains “absence”.

The logical library management unit 300 has a conversion function between the logical slot numbers and the physical slot numbers in each of the logical libraries, and a magazine loading/unloading detection function.

The conversion function between the logical slot numbers and the physical slot numbers in each of the logical libraries included in the logical library management unit 300 will be described. Upon reception of a request for accessing a logical slot of a logical library from the host apparatus 2, the control unit 10 transfers a logical library ID value of the logical library including the logical slot and a logical slot number of the logical slot to the logical library management unit 300. The logical library management unit 300 refers to the logical library configuration information table of the logical library configuration information table unit 310, and sends a physical slot number corresponding to the logical slot number to the control unit 10, and thereby, converts the logical slot number into the physical slot number in the logical library. Further, the control unit 10 accesses one of the tape cartridge media 700 installed in a physical slot corresponding to the physical slot number having been sent.

For example, upon reception of a request for accessing a logical slot having a logical slot number #0, included in the logical library having a logical library ID “2” from the host apparatus 2 in the logical library configuration information table of FIG. 3, the logical library management unit 300 sends “0” to the control unit 10 as a physical slot number corresponding thereto. As a result, the control unit 10 accesses one of the tape cartridge media 700, which is installed in a physical slot corresponding to the physical slot number #0 of the magazine whose magazine ID is “2”.

The magazine loading/unloading detection function is a function of updating the magazine presence or absence field of the logical library configuration information table included in the logical library configuration information table unit 310. Specifically, when having detected an event in which one of the magazines 70 has been loaded into one of the magazine slots 40, the logical library management unit 300 updates the above-described magazine presence or absence field on the basis of information indicating the magazine slot into which the relevant magazine 70 has been loaded and a magazine ID of the relevant magazine 70, which has been obtained from the ID reading unit 320. Further, when having detected an event in which one of the magazines 70 has been unloaded from one of the magazine slots 40, the logical library management unit 300 updates the above-described magazine presence or absence field on the basis of information indicating the magazine slot from which the relevant magazine 70 has been unloaded and a magazine ID of the relevant magazine 70, which has been obtained from the ID reading unit 320.

For example, a case where a magazine whose magazine ID is “1” has been loaded into the magazine slot 40-1 will be described. In this case, the logical library management unit 300 compares the physical slot number #0 to #5 allocated to the magazine slot 40-1 with respective numbers indicated in physical slot number fields corresponding to a magazine whose magazine ID, which is indicated in one of the magazine ID fields of the logical library configuration information table, is “1” (in the case of FIG. 3, the relevant numbers indicated in physical slot number fields being “0” to “5”). Further, if both of the numbers are matched with each other, the logical library management unit 300 updates a magazine presence or absence field corresponding to the relevant magazine ID field into “presence”.

Hereinbefore, configuration and operation of each of the components of the library apparatus 3 according to the first exemplary embodiment have been briefly described, and it is to be noted here that part of or the whole of the library apparatus 3 shown in FIG. 1 may be realized by a general computer system which operates under the program control, or may be realized by dedicated hardware.

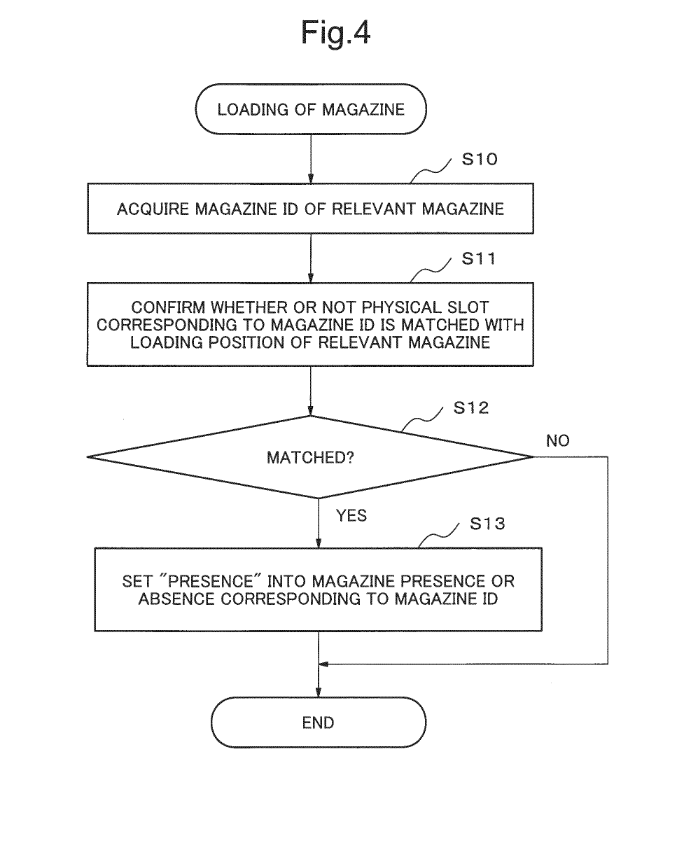

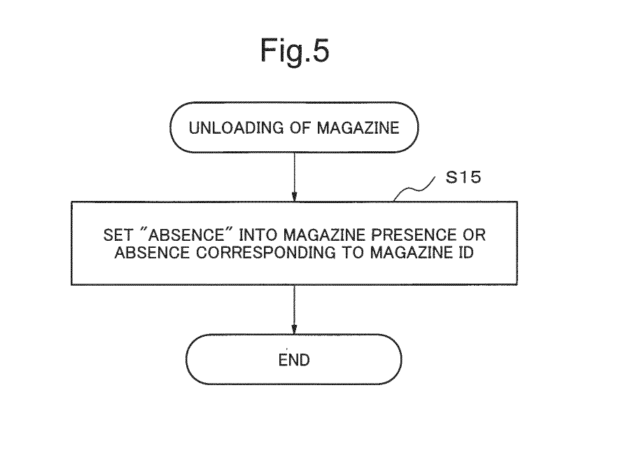

Next, operation of this exemplary embodiment will be described in detail with reference to flowcharts shown in FIGS. 4 and 5.

In this exemplary embodiment, physical slots defined for each of logical libraries can be allocated up to a number the same as a maximum number of physical slots the library apparatus 3 can deal with. That is, in partitioning control of logical libraries, according to this exemplary embodiment, two kinds of operations are performed, one being an operation for making logical slots usable by loading one of the magazines 70 into one of the magazine slots 40, the other one being an operation for making logical slots unusable by unloading one of the magazines 70 from one of the magazine slots 40.

FIG. 4 is a flowchart illustrating an outline of operation at the time of loading of a magazine, and FIG. 5 is a flowchart illustrating an outline of operation at the time when a magazine has been unloaded.

In addition, in the following description, it is supposed that values of the logical library configuration information table included in the logical library configuration information table unit 310 are set in advance. Further, the following description will be made under the assumption that, at first, no magazines are loaded in the library apparatus 3, and thus, every magazine presence or absence field of the logical library configuration information table is indicated by “absence”.

First, an outline of operation at the time of loading of a magazine will be described with reference to the flowchart shown in FIG. 4.

Referring to FIG. 4, when having detected an event in which one of the magazines 70 has been loaded into one of the magazine slots 40, the logical library management unit 300 instructs the ID reading unit 320 to acquire a magazine ID indicated by the magazine ID portion which is provided in the relevant magazine 70 (Step S10).

Next, the logical library management unit 300 searches the magazine ID fields of the logical library configuration information table included in the logical library configuration information table unit 310, for a magazine ID value which is matched with the magazine ID value having been acquired by the ID reading unit 320. Further, the logical library management unit 300 compares numbers of a physical slot number fields corresponding to a line of a magazine ID field in which a magazine ID value matched with the acquired magazine ID value is set, with physical slot numbers allocated to the magazine slot 40 into which the relevant magazine 70 has been loaded (Step S11).

If the two sets of numbers, having been compared in Step S11, are matched with each other (when the process flow branches to YES in Step S12), the logical library management unit 300 updates the content of a magazine presence or absence field of the same line as that of the relevant magazine ID field into “presence” (Step S13), and then, terminates the operation. As a result, logical slots of a logical library, which correspond to the relevant magazine 70, are made usable.

Meanwhile, if the two sets of numbers, having been compared in Step S11, are unmatched (when the process flow branches to NO in Step S12), the logical library management unit 300 terminates the operation without updating the logical library configuration information table of the logical library configuration information table unit 310. In this case, the control unit 10 may notify the host apparatus 2 of this unmatched situation.

Next, an outline of operation at the time of unloading of a magazine will be described with reference to the flowchart shown in FIG. 5.

Referring to FIG. 5, when having detected an event in which one of the magazines 70 has been unloaded from one of the magazine slots 40, the logical library management unit 300 updates the content of a magazine presence or absence field corresponding to a magazine ID which is included in one of the magazine ID fields of the logical library configuration information table, and which is matched with a magazine ID indicated by the magazine ID portion of the relevant magazine 70 having been unloaded, into “absence” (Step S15), and then, terminates the operation. As a result, logical slots of a logical library, which correspond to the relevant magazine 70, are made unusable.

As described above, in this exemplary embodiment, the physical slots can be defined for each of the logical libraries up to a number the same as a maximum number of physical slots the library apparatus 3 can deal with. Accordingly, the library apparatus 3 sets the “presence” or “absence” of each of the magazine presence or absence fields of the logical library configuration information table included in the logical library configuration information table unit 310 without making any change of configuration of the logical slots with respect to the logical libraries. That is, the library apparatus 3 makes it possible to control the allocation number of usable logical slots for each of the logical libraries by switching usable or unusable states of respective sets of the logical slots. As a result, this brings about an advantageous effect in that it becomes unnecessary to perform partitioning control such as re-partitioning of the logical libraries, and at the same time, it becomes also unnecessary to make any notification to the host apparatus, and perform any restarting operation.

A reason for this is that the library apparatus 3 retains the logical library configuration information table, which makes it possible to manage correspondences between a plurality of physical slots and a plurality of logical slots, in the logical library configuration information table unit 310. Further, another reason for this is that, through a loading position of the magazine 70 having been loaded into one of the magazine slots 40, and a magazine ID indicated by the magazine ID portion of the relevant magazine 70, the library apparatus 3 is configured so as to be capable of determining a set of logical slots of one of logical libraries, which corresponds to the loading position and the magazine ID, and switching the usable/unusable state of the set of logical slots.

### Second Exemplary Embodiment

Next, a second exemplary embodiment of the present invention will be described.

In the first exemplary embodiment, there is a problem that, in the logical library configuration information table included in the logical library configuration information table unit 310, unless one of the magazines 70 correlated with a certain logical library has been loaded into one of the magazine slots 40, which is allocated numbers the same as those of physical slot number fields corresponding to a line of a logical library ID field indicating the relevant logical library, any of logical slots corresponding to the relevant magazine 70 cannot be used. Here, the magazine slot 40, which is allocated numbers the same as those of physical slot number fields in the logical library configuration information table, means, for example, the magazine slot 40-1 in the case where the above numbers of the physical slot number fields are “0” to “5”, or the magazine slot 40-2 in the case where the above numbers of the physical slot number fields are “6” to “11”.

In this regard, according to this second exemplary embodiment, it is made possible to, whichever of the magazine slots 40 one of the magazines 70 has been loaded into, use logical slots corresponding to the relevant magazine 70.

Hereinafter, this second exemplary embodiment will be described in detail with reference to some of the drawings.

In addition, in the following description of this exemplary embodiment, components and operations identical to those of the first exemplary embodiment will be omitted from description.

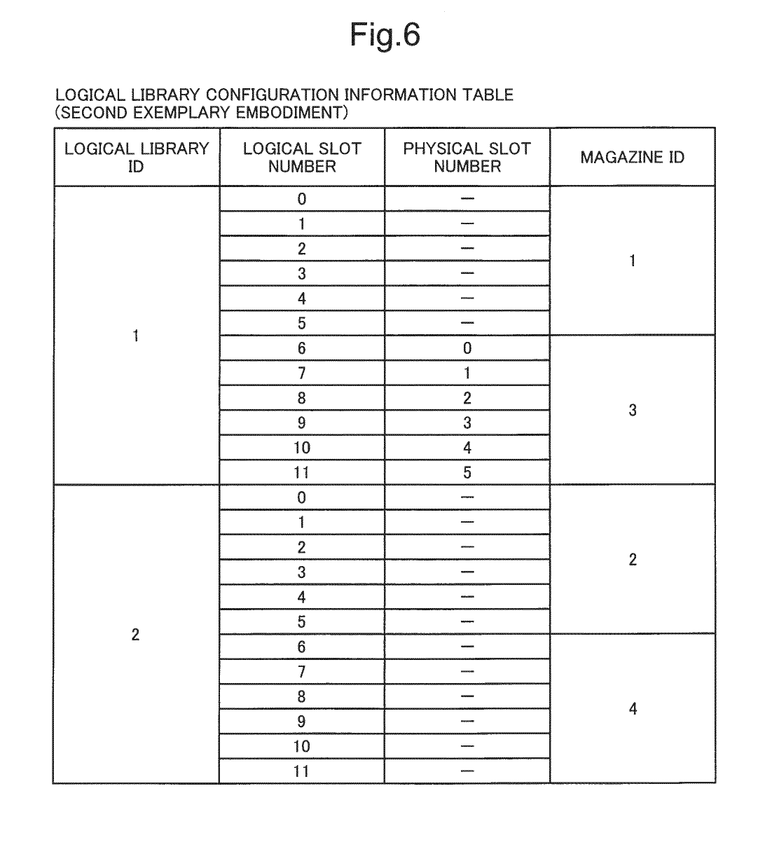

FIG. 6 is a diagram illustrating an example of a logical library configuration information table included in the logical library configuration information table unit 310, in this exemplary embodiment. In the table shown in FIG. 6, a first line indicates item names, and second and subsequent lines indicate an example of pieces of data corresponding to each of the item names.

Referring to FIG. 6, the logical library configuration information table according to this exemplary embodiment includes logical library ID fields, logical slot number fields, physical slot number fields and magazine ID fields. There are two differences with the case of the first exemplary embodiment, one being that the magazine presence or absence fields do not exist, the other one being a setting method for values of physical slot number fields.

A setting method for values of the physical slot number fields in this exemplary embodiment is such that, in the case of one of the magazines 70, which has a magazine ID indicated by a value of one of the magazine ID fields, and which has been loaded into one of the magazine slots 40, numbers the same as those of physical slot numbers which are allocated to the magazine slot 40, into which the relevant magazine 70 has been loaded, are set into corresponding physical slot number fields corresponding to the relevant magazine 70; while, in the case one of the magazines 70, which has a magazine ID indicated by a value of one of the magazine ID fields, and which is not loaded in any of the magazine slots 40, “-” is set into each of physical slot number fields corresponding to the relevant magazine 70.

When referring to second and subsequent lines of the logical library configuration information table shown in FIG. 6, a logical library indicated by a logical library ID “1” is composed of twelve logical slots indicated by respective logical slot numbers #0 to #11. Further, it can be understood that a magazine corresponding to logical slots having respective logical slot numbers #0 to #5 among the twelve logical slots is a magazine whose magazine ID is indicated by “1”. Further, it is illustrated that the relevant magazine is not loaded in any of the magazine slots 40. This can be understood from a fact in that “-” is indicated in each of physical slots corresponding to the magazine indicated by the magazine ID “1”.

Further, it can be understood that a magazine corresponding to logical slots having respective logical slot numbers #6 to #11 is a magazine whose magazine ID is indicated by “3”. Moreover, in FIG. 6, it is illustrated that the relevant magazine is loaded in the magazine slot 40-1. This can be understood from a fact in that, numbers the same as physical slot numbers “0” to “5” allocated to the magazine slot 40-1 are indicated in respective physical slot number fields corresponding to the relevant magazine.

Further, in FIG. 6, a logical library indicated by a logical library ID “2” is composed of twelve logical slots indicated by respective logical slot numbers #0 to #11. It can be understood that magazines corresponding to those logical slots are two magazines whose magazine IDs are indicated by “2” and “4”, respectively. Further, in FIG. 6, it is illustrated that each of the two relevant magazines is not loaded in any of the magazine slots 40. This can be understood form a fact in that “-” is indicated in each of the physical slot number fields corresponding to the two magazines described above.

In addition, numerical values included in the fields of the logical library configuration information table, except for numerical values included in the physical slot number fields, are reviewed at any time, such as in a system maintenance operation, and any numerical value which is necessary to be updated is updated.

The logical library management unit 300 according to this exemplary embodiment has a conversion function between the logical slot numbers and the physical slot numbers in each of the logical libraries, and a magazine loading/unloading detection function, just like the case of the first exemplary embodiment. Nevertheless, a magazine loading/unloading detection function of this exemplary embodiment is different from the magazine loading/unloading detection function of the logical library management unit 300 according to the first exemplary embodiment. The magazine loading/unloading detection function of the logical library management unit 300 according to this exemplary embodiment has a function of updating physical slot number fields of the logical library configuration information table included in the logical library configuration information table unit 310.

That is, when having detected an event in which one of magazines 70 has been loaded into one of the magazine slots 40, the logical library management unit 300 updates the above physical slot number fields on the basis of information indicating the magazine slot 40, into which the relevant magazine 70 has been loaded, and a magazine ID of the relevant magazine 70, which has been obtained from the ID reading unit 320. Moreover, when having detected an event in which one of the magazines 70 has been unloaded from one of the magazine slots 40, the logical library management unit 300 updates the above physical slot number fields on the basis of information indicating the magazine slot 40, from which the relevant magazine 70 has been unloaded, and a magazine ID of the relevant magazine 70, which has been obtained from the ID reading unit 320.

An outline of functions and operations of other components is the same as that in the first exemplary embodiment, and thus, description thereof is omitted here.

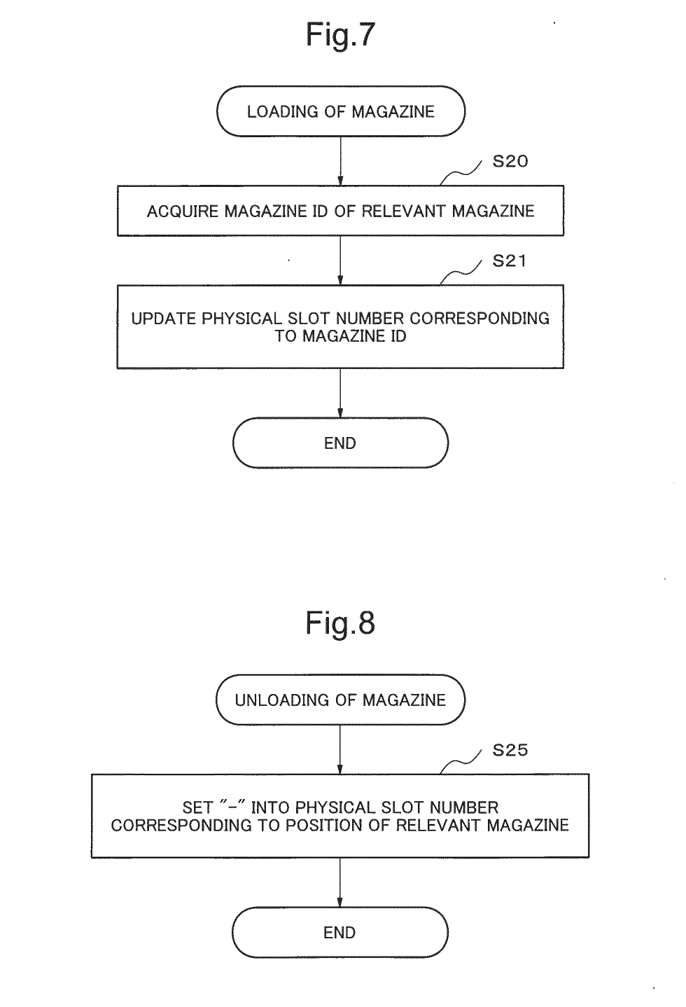

Next, operation of this second exemplary embodiment will be described in detail with reference to flowcharts shown in FIGS. 7 and 8 and the logical library configuration information table shown in FIG. 6.

FIG. 7 is a flowchart illustrating an outline of operation at the time of loading of a magazine, and FIG. 8 is a flowchart illustrating an outline of operation at the time of unloading of a magazine.

In addition, it is supposed that values of the logical library configuration information table included in the logical library configuration information table unit 310 are set in advance. Moreover, the following description will be made under the assumption that, at first, no magazines are loaded in the library apparatus 3, and thus, the content of every physical slot number field of the logical library configuration information table is “-”.

First, operation at the time of loading of a magazine will be described with reference to the flowchart shown in FIG. 7.

Referring to FIG. 7, first, when having detected an event in which one of the magazines 70 has been loaded into one of the magazine slots 40, the logical library management unit 300 instructs the ID reading unit 320 to acquire a magazine ID which is indicated by the magazine ID portion provided in the relevant magazine 70 (Step S20).

Next, the logical library management unit 300 searches the magazine ID fields of the logical library configuration information table included in the logical library configuration information table unit 310, for a magazine ID value which is matched with the magazine ID value having been acquired by the ID reading unit 320. Further, the logical library management unit 300 sets numbers the same as physical slot numbers allocated to the magazine slot 40, into which the relevant magazine 70 has been loaded, into physical slot number fields corresponding to a line of a magazine ID field in which a magazine ID matched with the acquired magazine ID is set (Step S21), and then, terminates the operation. As a result, logical slots of a logical library, which correspond to the relevant magazine 70, are made usable.

For example, as shown in FIG. 6, when a magazine whose magazine ID is a number “3” has been loaded into the magazine slot 40-1, the logical library management unit 300 searches the magazine ID fields of the logical library configuration information table for a magazine ID value which is matched with the number “3”. Further, the logical library management unit 300 sets numbers “0” to “5”, which are the same as physical slot numbers #0 to #5 allocated to the magazine slot 40-1, into physical slot number fields corresponding to a line of a magazine ID field in which the number “3” is set as a value of the magazine ID.

Next, operation at the time of unloading of a magazine will be described with reference to the flowchart shown in FIG. 8.

Referring to FIG. 8, first, when having detected an event in which one of the magazines 70 has been unloaded from one of the magazine slots 40, the logical library management unit 300 searches the magazine ID fields of the logical library configuration information table, for a magazine ID value which is matched with a magazine ID value indicated by the magazine ID portion of the unloaded magazine 70 (Step S20). Further, the logical library management unit 300 updates each of values of physical slot number fields corresponding to a line of a magazine ID field, in which the magazine ID value having been searched for is set, into “-” (Step S25), and then, terminates the operation. As a result, logical slots of a logical library, which correspond to the relevant magazine 70 are made unusable.

For example, as shown in FIG. 6, when a magazine whose magazine ID is a number “2” has been unloaded from one of the magazine slots 40, the logical library management unit 300 searches the magazine ID fields of the logical library configuration information table for a magazine ID value which is matched with the number “2”. Further, the logical library management unit 300 sets “-” into each of physical slot number fields corresponding to a line of a magazine ID field in which the number “2” is set as a magazine ID value.

As described above, in this exemplary embodiment, there is an advantageous effect in that, into whichever of the magazine slots 40 one of the magazines 70 has been loaded, logical slots corresponding to the relevant magazine 70 can be used.

A reason for this is that the library apparatus 3 sets numbers the same as physical slot numbers which are allocated to one of the magazine slots 40, into which one of the magazines 70 has been loaded, into corresponding physical slot number fields of the logical library configuration information table. Another reason for this is that the library apparatus 3 is configured to, when the relevant magazine 70 is not loaded in any of the magazine slots 40, set “-” into each of the corresponding physical slot number fields. As a result, it becomes unnecessary to set, in advance, physical slot numbers which are allocated to each of the magazine slots 40, in which a corresponding one of the magazines 70 is to be loaded (for example, the physical slot numbers being numbers “0” to “5” in the case of the magazine slot 40-1, and numbers “6” to “11” in the case of the magazine slot 40-2).

### Third Exemplary Embodiment

Next, a third exemplary embodiment of the present invention will be described.

In the first and second exemplary embodiments, information related to correspondence relations between logical slots constituting logical libraries and magazine IDs for identifying the magazines 70 is retained in the logical library configuration information table included in the logical library configuration information table unit 310 of the library apparatus 3. In this third exemplary embodiment, a partition information table, which indicates which of logical slots constituting one of logical libraries each of medium slots included in each of magazines corresponds to, is stored in a partition information unit provided in the each of magazines.

Hereinafter, this third exemplary embodiment will be described in detail with reference to some of the drawings.

In addition, in the following description of this exemplary embodiment, components and operations identical to those of the first and second exemplary embodiments will be omitted from description.

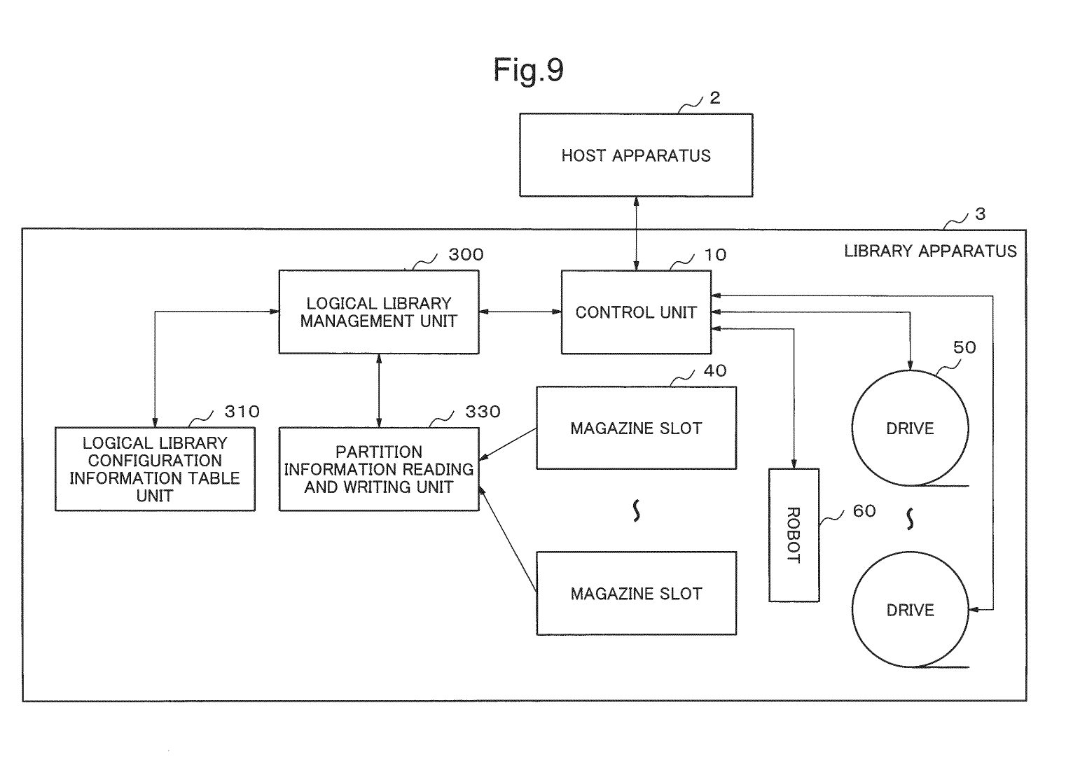

FIG. 9 is a block diagram illustrating an outline of a library apparatus according to this exemplary embodiment.

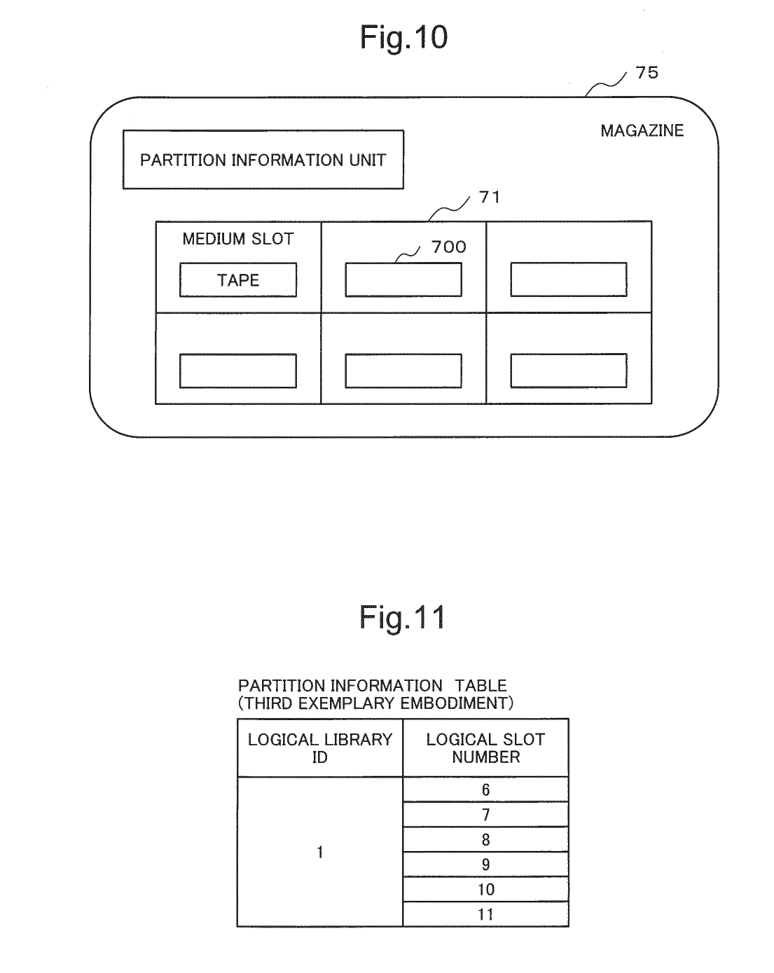

Referring to FIG. 9, a library apparatus 3 according to this exemplary embodiment is configured almost in the same manner as the library apparatus 3 according to the first and second exemplary embodiments. The library apparatus 3 according to this exemplary embodiment is different from the library apparatus 3 according to the first and second exemplary embodiments described above in the respect that the library apparatus 3 according to this exemplary embodiment is not provided with the ID reading unit 320, which reads a magazine ID indicated by the magazine ID portion provided in each of the magazines 70, but is provided with a partition information reading and writing unit 330. The partition information reading and writing unit 330 accesses information included in the partition information table which is stored in a partition information unit provided in a magazine 75 (FIG. 10).

Next, a configuration of the magazine 75 to be loaded in one of the magazine slots 40 in this exemplary embodiment is illustrated in FIG. 10.

Referring to FIG. 10, the magazine 75 is configured almost in the same manner as the magazine 70 according to the first and second exemplary embodiments. The magazine 75 according to this exemplary embodiment is different from the magazine 70 according to the first and second exemplary embodiments in the respect that the magazine ID portion for indicating a magazine ID, which is identification information for identifying a corresponding one of the magazines, is not provided, but the above-described partition information unit which stores therein the partition information table is provided.

FIG. 11 is a diagram illustrating an example of the partition information table stored in the partition information unit included in the magazine 75 in this exemplary embodiment. In the table shown in FIG. 11, a first line indicates item names, and second and subsequent lines indicate an example of pieces of data corresponding to each of the item names.

Referring to FIG. 11, the partition information table of this exemplary embodiment includes a logical library ID field and logical slot number fields. When, in FIG. 11, referring to second and subsequent lines, it can be understood that medium slots included in this magazine correspond to respective six logical slots which are indicated by logical slot numbers “6” to “11” of a logical library whose logical library ID is indicated by “1”.

In addition, the partition information unit may be realized by a non-volatile memory fixedly provided in the magazine 75, or may be realized by a non-volatile storage medium attachable and detachable to the magazine 75, but a method for realizing the partition information unit is not necessarily limited to these methods. Further, with respect to the partition information reading and writing unit 330, in accordance with a method for realizing the partition information unit, a reading mechanism corresponding to the method should be employed.

In addition, numerical values included in the partition information table are reviewed at any time, such as in a system maintenance, and any numerical value which is necessary to be updated is updated.

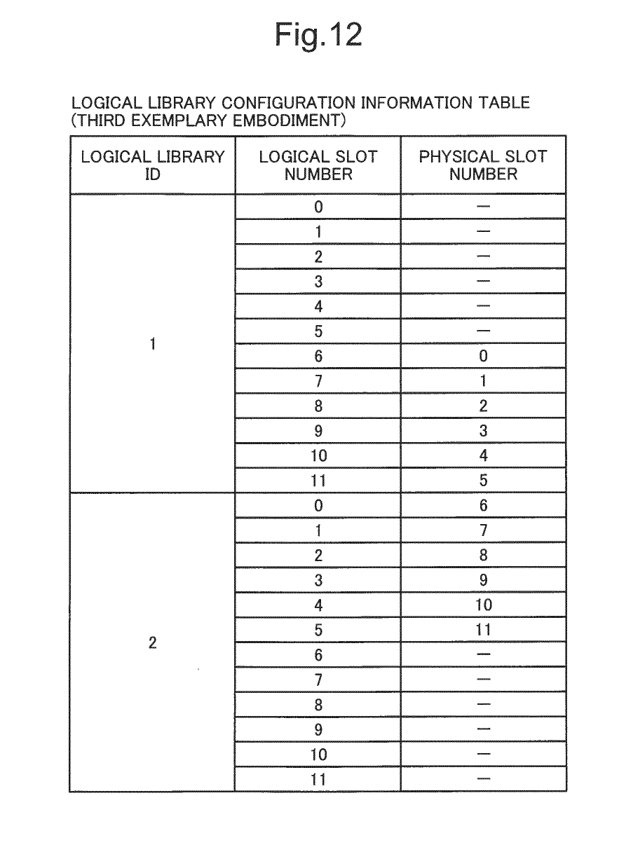

FIG. 12 is a diagram illustrating an example of the logical library configuration information table included in the logical library configuration information table unit 310 in this exemplary embodiment. In the table shown in FIG. 12, a first line indicates item names, and second and subsequent lines indicate an example of pieces of data corresponding to each of the item names.

Referring to FIG. 12, the logical library configuration information table of this exemplary embodiment includes logical library ID fields, logical slot number fields and physical slot number fields. The logical library configuration information table of this exemplary embodiment is different from the logical library configuration information table of the second exemplary embodiment in the respect that the magazine ID fields do not exist.

When, in FIG. 12, referring to second and subsequent lines, a logical library whose logical library ID is indicated by “1” is composed of twelve logical slots indicated by respective logical slot numbers #0 to #11. Further, it is illustrated in FIG. 12 that a magazine corresponding to logical slot numbers #0 to #5 of the above twelve logical slots is not loaded in a corresponding one of the magazine slots 40. This can be understood from a fact in that each of physical slot number fields corresponding to the relevant magazine is indicated by“-”.

Further, it is illustrated in FIG. 12 that a magazine corresponding to logical slot numbers #6 to #11 is loaded in the magazine slot 40-1. This can be understood from a fact in that numbers the same as physical slot numbers “0” to “5” allocated to the magazine slot 40-1 are indicated in respective physical slot number fields corresponding to the relevant magazine.

In addition, numerical values included in the logical library configuration information table, except for numerical values included in the physical slot number fields, are reviewed at any time, such as in a system maintenance, and any numerical value which is necessary to be updated is updated.

The logical library management unit 300 of this exemplary embodiment has a conversion function between logical slot numbers and physical slot numbers in any one of the logical libraries, and a magazine loading/unloading detection function, just like the case of the second exemplary embodiment. Nevertheless, the magazine loading/unloading detection function of this exemplary embodiment is different from the magazine loading/unloading detection function of the second exemplary embodiment. The magazine loading/unloading detection function of this exemplary embodiment has a function of updating physical slot number fields of the logical library configuration information table included in the logical library configuration information table unit 310 by using information included in the partition information table, which has been obtained from the partition information reading and writing unit 330. In addition, details of operation of this magazine loading/unloading detection function in this exemplary embodiment will be described below.

The partition information reading and writing unit 330 of this exemplary embodiment has a function of receiving an instruction from the logical library management unit 300, reading the content of the partition information table of the partition information unit provided in one of the magazines 75 which has been loaded in one of the magazine slots 40, and sending it to the logical library management unit 300. An outline of functions and operations of other components is the same as that in the first and second exemplary embodiments, and thus, description thereof is omitted here.

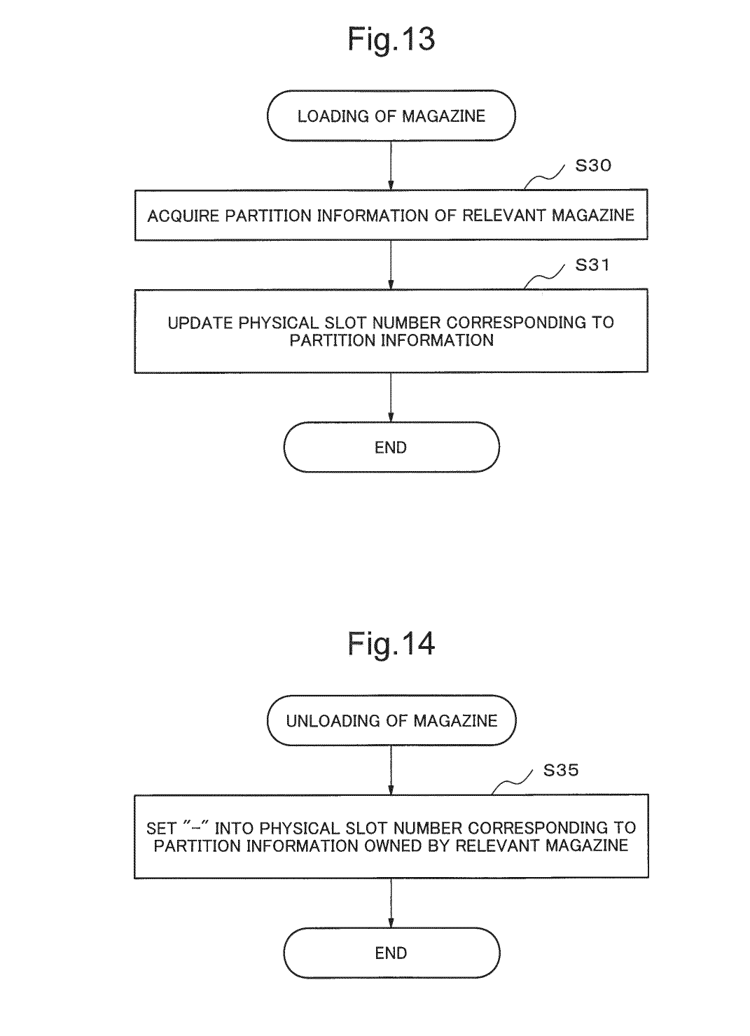

Next, operation of this third exemplary embodiment will be described in detail with reference to flowcharts shown in FIGS. 13 and 14, a partition information table shown in FIG. 11 and a logical library configuration information table shown in FIG. 12.

FIG. 13 is a flowchart illustrating an outline of operation at the time of loading of a magazine, and FIG. 14 is a flowchart illustrating an outline of operation at the time of unloading of a magazine.

Further, it is supposed that values of the partition information table of the partition information unit included in the magazine 75 and values of the logical library configuration information table of the logical library configuration information table unit 310 are set in advance. Moreover, the following description will be made under the assumption that, at first, no magazines are loaded in the library apparatus 3, and thus, the content of every physical slot number field of the logical library configuration information table is “-”.

First, operation at the time of loading of a magazine will be described with reference to the flowchart shown in FIG. 13.

Referring to FIG. 13, first, when having detected an event in which one of the magazines 75 has been loaded into one of the magazine slots 40, the logical library management unit 300 instructs the partition information reading and writing unit 330 to read the content of the partition information table stored in the partition information unit provided in the relevant magazine 75 (Step S30).

Next, the logical library management unit 300 searches the logical library ID fields and the logical slot number fields of the logical library configuration information table for a logical library ID value and a logical slot number which are matched with a logical library ID value and a logical slot number of the partition information table, which have been acquired by the partition information reading and writing unit 330. Further, the logical library management unit 300 sets numbers the same as physical slot numbers which are allocated to the magazine slot 40, into which the relevant magazine 75 has been loaded, into respective physical slot number fields corresponding to a line of a logical library ID field and a logical slot number field in which a logical library ID field value and a logical slot number matched with the acquired logical library ID value and the acquired logical slot number of the partition information table, respectively, are set (Step S31), and then, terminates the operation. As a result, logical slots of a logical library, which correspond to the relevant magazine 75, are made usable.

For example, it is supposed that one of the magazines 75, which includes a partition information unit having a partition information table, the content of which is such that a logical library ID is “1” and logical slot numbers are “6” to “11”, as shown in FIG. 11, has been loaded into the magazine slot 40-1. In this case, the logical library management unit 300 searches the logical library ID fields of the logical library configuration information table for a logical library ID value which is matched with the number “1”. Moreover, the logical library management unit 300 searches the logical slot number fields for logical slot numbers which are matched with the respective numbers “6” to “11”. Further, the logical library management unit 300 sets numbers “0” to “5”, which are the same as physical slot numbers #0 to #5 allocated to the magazine slot 40-1, into respective physical slot number fields corresponding to lines of logical slot number fields in which the logical slot numbers having been searched for are set.

In addition, in the case where, in the above-described step S31, a value of the logical library ID field of the partition information table included in the partition information unit of the relevant magazine 75 is a value which does not exist in any of the logical library ID fields of the logical library configuration information table included in the logical library configuration information table unit 310, the logical library management unit 300 may report the occurrence of an error to the control unit 10. Further, in the above case, the logical library management unit 300 may newly add a logical library ID field, logical slot number fields and physical slot number fields to the logical library configuration information table of the logical library configuration information table unit 310.

Next, operation at the time of unloading of a magazine will be described with reference to the flowchart shown in FIG. 14.

Referring to FIG. 14, first, when having detected an event in which one of the magazines 75 has been unloaded from one of the magazine slots 40, the logical library management unit 300 searches the logical library ID fields and the logical slot number fields of the logical library configuration information table for a logical library ID value and a logical slot number which are matched with a logical library ID value and a logical slot number of the partition information table retained by the partition information unit of the relevant magazine 75 having been unloaded. Further, the logical library management unit 300 updates each of values of physical slot number fields corresponding to a line of a logical library ID field and logical slot number fields in which the logical library ID value and the logical slot numbers having been searched for are set, respectively, into “-” (Step S35), and then, terminates the operation. As a result, logical slots of a logical library, which correspond to the relevant magazine 75, are made unusable.

For example, it is supposed that one of the magazines 75, which includes a partition information unit having a partition information table, the content of which is such that a logical library ID is “2” and logical slot numbers are “6” to “11”, is unloaded from one of the magazine slots 40. In this case, the logical library management unit 300 searches the logical library ID fields of the logical library configuration information table for a logical library ID value which is matched with the number “2”. Moreover, the logical library management unit 300 searches the logical slot number fields for logical slot numbers which are matched with the respective numbers “6” to “11”. Further, as shown in FIG. 12, the logical library management unit 300 updates each of physical slot number fields, which correspond to lines of respective logical slot number fields in which the logical slot numbers having been searched for are set, into “-”.

As described above, in this exemplary embodiment, there is an advantageous effect in that it is unnecessary to define, in advance, information related to correspondence relations between logical slots constituting each of logical libraries and magazine IDs for identifying the respective magazines 75 in the logical library configuration information table included in the logical library configuration information table unit 310 of the library apparatus 3.

A reason for this is that partitioning information, which indicates which ones of logical slots constituting one of libraries medium slots included in each of magazines correspond to, is retained in the partition information table included in the partition information unit provided in the each of magazines.

### Fourth Exemplary Embodiment

Next, a fourth exemplary embodiment of the present invention will be described.

In the first to third exemplary embodiments, there is a problem that the number of logical slots which can be defined for each of logical libraries is merely up to a number the same as a maximum number of physical slots the library apparatus 3 is capable of dealing with.

In this fourth exemplary embodiment, therefore, it is made possible to allocate logical slots, the number of which exceeds a maximum value of physical slots the library apparatus 3 is capable of dealing with, to each of libraries

Hereinafter, this fourth exemplary embodiment will be described in detail with reference to some of the drawings.

Further, in the following description of this exemplary embodiment, components and operations identical to those of the first to third exemplary embodiments will be omitted from description.

Further, in the following description, operation in a case based on the configuration of the second exemplary embodiment will be described, but, in a case based on the configuration of the third exemplary embodiment, similar operation can be also performed.

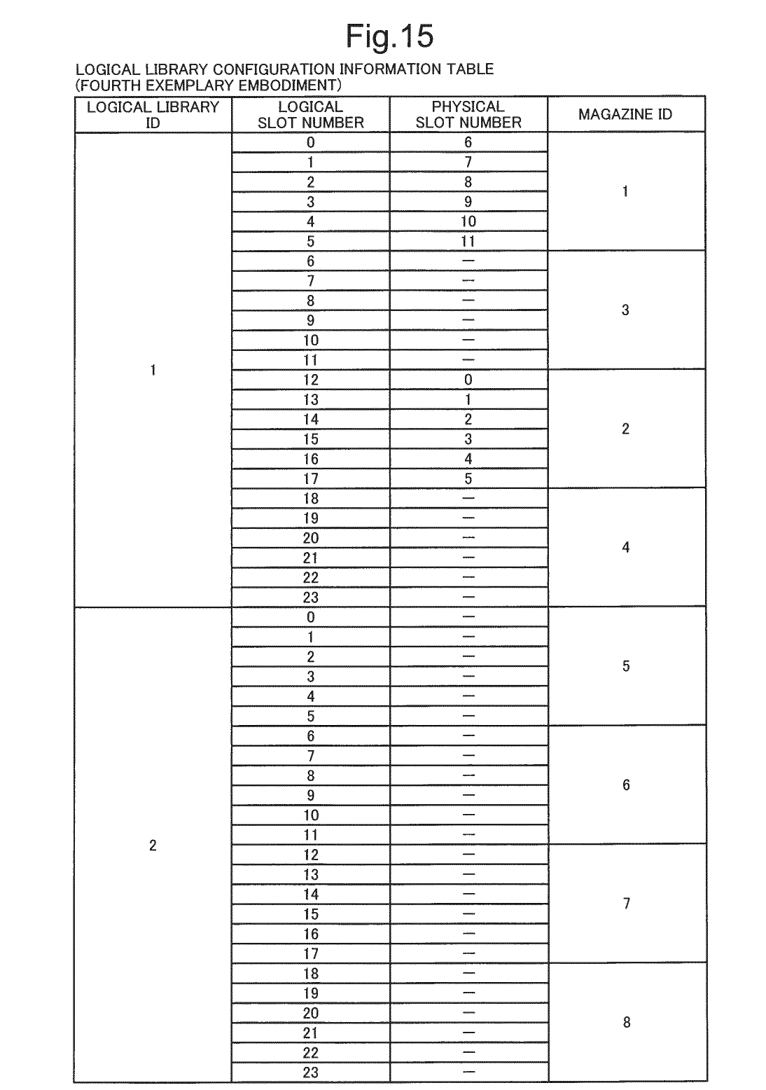

FIG. 15 is a diagram illustrating an example of a logical library configuration information table included in the logical library configuration information table unit 310 in this exemplary embodiment. In the table shown in FIG. 15, a first line indicates item names, and second and subsequent lines indicate an example of pieces of data corresponding to each of the item names.

Referring to FIG. 15, the logical library configuration information table of this exemplary embodiment includes logical library ID fields, logical slot number fields, physical slot number fields and magazine ID fields, and has the same structure as that of the logical library configuration information table of the second exemplary embodiment.

A difference with the logical library configuration information table of the second exemplary embodiment is that the number of logical slots set in a certain logical library is made larger than a maximum value of the number of physical slots which can be simultaneously used in the library apparatus 3.

When, in FIG. 15, referring to second and subsequent lines, a logical library whose logical library ID is indicated by “1” is composed of twenty-four logical slots indicated by respective logical slot numbers #0 to #23. In this exemplary embodiment, a maximum value of the number of physical slots which can be simultaneously used in the library apparatus 3 is “12” resulting from summing “6” which is the number of physical slots of the magazine slot 40-1 and “6” which is the number of physical slots of the magazine slot 40-2. Accordingly, it can be understood that, in the logical library configuration information table shown in FIG. 15, the number of logical slots having been set is larger than the maximum value of the number of physical slots which can be simultaneously used in the library apparatus 3.

Further, a magazine corresponding to logical slot numbers #0 to #5 of the above twenty-four logical slots is a magazine whose magazine ID is indicated by “1”, and this magazine is loaded in the magazine slot 40-2. This can be understood by a fact in that, values of physical slot number fields, corresponding to the above logical slot numbers, indicate numbers the same as the physical slot numbers “6” to “11” allocated to the magazine slot 40-2.

Further, a magazine corresponding to logical slot numbers #12 to #17 of the above twenty-four logical slots is a magazine whose magazine ID is indicated by “2”, and this magazine is loaded in the magazine slot 40-1. This can be understood by a fact in that, values of physical slot number fields, corresponding to the above logical slot numbers, indicate numbers the same as the physical slot numbers “0” to “5” allocated to the magazine slot 40-1.

Further, in FIG. 15, it is illustrated that a magazine corresponding to logical slot numbers #6 to #11 and a magazine corresponding to logical slot numbers #18 to #23 are a magazine whose magazine ID is indicated by “3” and a magazine whose magazine ID is indicated by “4”, respectively, and each of the relevant magazines is not loaded in any of the magazine slots 40. This can be understood by a fact in that each of values of the physical slot number fields, corresponding to the above logical slot numbers, is indicated by “-”.

Further, it can be understood from FIG. 15 that a logical library whose logical library ID is indicated by “2” is also composed of twenty-four logical slots which are indicated by respective logical slot numbers #0 to #23, and magazines corresponding to respective these logical slots are four magazines whose magazine IDs are indicated by respective “5” to “8”. Further, it is illustrated in FIG. 15 that each of the above magazines is not loaded in any of the magazine slots 40. This can be understood by a fact in that each of values of the physical slot number fields, corresponding to the above logical slot numbers, is indicated by “-”.

In addition, numerical values included in the logical library configuration information table, except for numerical values included in the physical slot number fields, are reviewed at any time, such as in a system maintenance, and any numerical value which is necessary to be updated is updated.

Functions of other components and operation of the library apparatus 3 of this exemplary embodiment are the same as those of the second exemplary embodiment, and thus, description thereof is omitted here.

As described above, in this exemplary embodiment, there is an advantageous effect in that it is possible to allocate logical slots, the number of which is larger than a maximum value of the number of physical slots the library apparatus 3 can simultaneously deal with, to each of logical libraries.

A reason for this is that logical libraries each including logical slots, the number of which is larger than a maximum value of the number of physical slots which can be simultaneously used by the library apparatus 3, are set in the logical library configuration information table included in the logical library configuration information table unit 310.

The whole or part of the exemplary embodiments disclosed above can be described as, but not limited to, the following supplementary notes.

(Supplementary Note 1)

A library apparatus including:

a plurality of magazines, each magazine including at least one medium slot in each of which a removable storage medium is stored, and a magazine ID portion which indicates a magazine ID which is information for identifying itself;

at least one magazine slot, each magazine slot being allocated at least one physical slot number which, at a time when one of the magazines has been loaded into the each magazine slot, is allocated to the at least one medium slot of the relevant magazine on a one-to-one correspondence basis;

an ID reading unit configured to read a magazine ID which is indicated by the magazine ID portion of one of the magazines which has been loaded into one of the at least one magazine slot;

a logical library configuration information table including at least one logical library ID each being information for identifying one of at least one logical library which is logically partitioned, at least one logical slot number each indicating a number of a corresponding one of at least one logical slot included in each of the at least one logical library, the at least one physical slot number which is allocated to each of the at least one magazine slot, and which corresponds to the at least one logical slot number, the magazine ID which is indicated by the magazine ID portion provided in a certain one of the magazines, which is to be loaded in one of the at least one magazine slot, and magazine presence or absence information which indicates whether any one of the magazines is loaded, or not, for each of the at least one magazine slot; and

a logical library management unit configured to, when having detected an event in which one of the magazines has been loaded into one of the at least one magazine slot, update the magazine presence or absence information included in the logical library configuration information table, on the basis of information indicating the magazine slot into which the relevant magazine has been loaded, and the magazine ID which corresponds to the relevant magazine, and which has been read by the ID reading unit.

(Supplementary Note 2)

The library apparatus according to supplementary note 1, wherein, when having detected an event in which one of the magazines has been unloaded from one of the at least one magazine slot, the logical library management unit updates the magazine presence or absence information included in the logical library configuration information table into information indicating that the relevant magazine does not exist in the magazine slot from which the relevant magazine has been unloaded, on the basis of information indicating the magazine slot from which the relevant magazine has been unloaded, and the magazine ID which corresponds to the relevant magazine, and which has been read by the ID reading unit.

(Supplementary Note 3)

A library apparatus including:

a plurality of magazines, each magazine including at least one medium slot in each of which a removable storage medium is stored, and a magazine ID portion which indicates a magazine ID which is information for identifying itself;

at least one magazine slot, each magazine slot being allocated at least one physical slot number which, at a time when one of the magazines has been loaded into the each magazine slot, is allocated to the at least one medium slot of the relevant magazine on a one-to-one correspondence basis;

an ID reading unit configured to read a magazine ID which is indicated by the magazine ID portion of one of the magazines which has been loaded into one of the at least one magazine slot;

a logical library configuration information table including at least one logical library ID each being information for identifying one of at least one logical library which is logically partitioned, at least one logical slot number each indicating a number of a corresponding one of at least one logical slot included in each of the at least one logical library, the at least one physical slot number which is allocated to each of the at least one magazine slot, and which corresponds to the at least one logical slot number, and the magazine ID which is indicated by the magazine ID portion provided in a certain one of the magazines, which is loaded in one of the at least one magazine slot; and

a logical library management unit configured to, when having detected an event in which one of the magazines has been loaded into one of the at least one magazine slot, update the at least one physical slot number of the logical library configuration information table into a number the same as the at least one physical slot number being allocated to the at least one medium slot of the relevant medium, on the basis of information indicating the magazine slot into which the relevant magazine has been loaded, and the magazine ID which corresponds to the relevant magazine, and which has been read by the ID reading unit.

(Supplementary Note 4)

The library apparatus according to supplementary note 3, wherein, when having detected an event in which one of the magazines has been unloaded from one of the at least one magazine slot, the logical library management unit updates each of the at least one physical slot number which is included in the logical library configuration information table, and which corresponds to the relevant magazine, into information indicating that the relevant magazines does not in the magazine slot from which the relevant magazine has been unloaded, on the basis of information indicating the magazine slot from which the relevant magazine has been unloaded, and the magazine ID which corresponds to the relevant magazine, and which has been read by the ID reading unit.

(Supplementary Note 5)

A library apparatus including:

a plurality of magazines, each magazine including at least one medium slot in each of which a removable storage medium is stored, and a partition information unit which stores therein a logical library ID being information for identifying a certain one of at least one logical library which is logically partitioned, and at least one logical slot number each indicating a number of a corresponding one of at least one logical slot included in the certain one of at least one logical library;

at least one magazine slot, each magazine slot being allocated at least one physical slot number which, at a time when one of the magazines has been loaded into the each magazine slot, is allocated to the at least one medium slot of the relevant magazine on a one-to-one correspondence basis;

a partition information reading and writing unit configured to access the partition information unit of the one of the magazines which has been loaded into the one of the at least one magazine slot;

a logical library configuration information table including the at least one logical library ID, the at least one logical slot number, and the at least one physical slot number which is allocated to each of the at least one magazine slot, and which corresponds to the at least one logical slot number; and

a logical library management unit configured to, when having detected an event in which one of the magazines has been loaded into one of the magazine slots, update each of the at least one physical slot number included in the logical library configuration information table into a number the same as a corresponding one of the at least one physical slot number being allocated to the at least one medium slot of the relevant magazine, on the basis of the logical library ID and the at least one logical slot number, which correspond to the at least one medium slot of the relevant magazine, and which have been acquired by the partition information reading and writing unit.

(Supplementary Note 6)

The library apparatus according to supplementary note 5, wherein, when having detected an event in which one of the magazines has been unloaded from one of the at least one magazine slot, the logical library management unit updates each of the at least one physical slot number included in the logical library configuration information table into information indicating that the relevant magazine does not exist in the relevant magazine slot, on the basis of the logical library ID and the at least one logical slot number, which correspond to the at least one medium slot of the relevant magazine, and which have been acquired by the partition information reading and writing unit.

(Supplementary Note 7)

A partitioning control method for use in a library apparatus including at least one magazine slot and a logical library configuration information table, the partitioning control method including:

detecting an event in which one of a plurality of magazines each storing therein at least one removable storage medium has been loaded into one of the at least one magazine slot each of which is allocated at least one physical slot number, and acquiring a magazine ID which is information for identifying the relevant magazine, and which is owned by the relevant magazine having been loaded into the relevant magazine slot;

searching the logical library configuration information table for a magazine ID of the relevant magazine, a value of which is matched with a value of the acquired magazine ID;

comparing at least one physical slot number which is included in the logical library configuration information table, and which corresponds to the magazine ID having been searched for with at least one physical slot number which is allocated to the relevant magazine slot into which the relevant magazine has been loaded; and

with respect magazine presence or absence information for indicating whether or not a corresponding one of the plurality of magazines is loaded in one of the at least one magazine slot, updating the magazine presence or absence information corresponding to the at least one physical slot number which is included in the logical library configuration information table, and which has been matched with the at least one physical slot number which is allocated to the relevant magazine slot.

(Supplementary Note 8)

A partitioning control method for use in a library apparatus including at least one magazine slot and a logical library configuration information table, the partitioning control method including:

detecting an event in which one of a plurality of magazines each storing therein at least one removable storage medium has been loaded into one of the at least one magazine slot each of which is allocated at least one physical slot number, and acquiring a magazine ID which is information for identifying the relevant magazine, and which is owned by the relevant magazine having been loaded into the relevant magazine slot;

searching the logical library configuration information table for a magazine ID of the relevant magazine, a value of which is matched with a value of the acquired magazine ID; and

setting at least one physical slot number which is allocated to the relevant magazine slot into which the relevant magazine has been loaded, into at least one physical slot number which is included in the logical library configuration information table, and which corresponds to the magazine ID having been searched for.

(Supplementary Note 9)

A partitioning control method for use in a library apparatus including at least one magazine slot and a logical library configuration information table, the partitioning control method including:

detecting an event in which one of a plurality of magazines each storing therein at least one removable storage medium has been loaded into one of the at least one magazine slot each of which is allocated at least one physical slot number, and acquiring a logical library ID which is stored in a partition information table included in the relevant magazine, and which is information for identifying a corresponding one of at least one logical library which is logically partitioned, and at least one logical slot number which is stored in the partition information table, and each of which indicates a corresponding number of at least one logical number included in the corresponding one of at least one logical library;

searching the logical library configuration information table for a logical library ID and at least one logical slot number, a value of the logical library ID and a value of each of the at least one logical slot number being matched with a value of the logical library ID having been acquired and a value of each of the at least one logical slot number having been acquired, respectively; and

setting at least one physical slot number which is allocated to the relevant magazine slot into which the relevant magazine has been loaded, into at least one physical slot number which is included in the logical library configuration information table, and which corresponds to the logical library ID and the at least one logical slot number having been searched for.

(Supplementary Note 10)

A program storage medium that records therein a partitioning control program executed by a computer including at least one magazine slot and a logical library configuration information table, the partitioning control program including the processes of:

detecting an event in which one of a plurality of magazines each storing therein at least one removable storage medium has been loaded into one of the at least one magazine slot each of which is allocated at least one physical slot number, and acquiring a magazine ID which is information for identifying the relevant magazine, and which is owned by the relevant magazine having been loaded into the relevant magazine slot;

searching the logical library configuration information table for a magazine ID of the relevant magazine, a value of which is matched with a value of the acquired magazine ID;

comparing at least one physical slot number which is included in the logical library configuration information table, and which corresponds to the magazine ID having been searched for with at least one physical slot number which is allocated to the relevant magazine slot into which the relevant magazine has been loaded; and

with respect magazine presence or absence information for indicating whether or not a corresponding one of the plurality of magazines is loaded in one of the at least one magazine slot, updating the magazine presence or absence information corresponding to the at least one physical slot number which is included in the logical library configuration information table, and which has been matched with the at least one physical slot number which is allocated to the relevant magazine slot.

(Supplementary Note 11)

A program storage medium that records therein a partitioning control program executed by a computer including at least one magazine slot and a logical library configuration information table, the partitioning control program including the processes of:

detecting an event in which one of a plurality of magazines each storing therein at least one removable storage medium has been loaded into one of the at least one magazine slot each of which is allocated at least one physical slot number, and acquiring a magazine ID which is information for identifying the relevant magazine, and which is owned by the relevant magazine having been loaded into the relevant magazine slot;

searching the logical library configuration information table for a magazine ID of the relevant magazine, a value of which is matched with a value of the acquired magazine ID; and

setting at least one physical slot number which is allocated to the relevant magazine slot into which the relevant magazine has been loaded, into at least one physical slot number which is included in the logical library configuration information table, and which corresponds to the magazine ID having been searched for.

(Supplementary Note 12)

A program storage medium that records therein a partitioning control program executed by a computer including at least one magazine slot and a logical library configuration information table, the partitioning control program including the processes of:

detecting an event in which one of a plurality of magazines each storing therein at least one removable storage medium has been loaded into one of the at least one magazine slot each of which is allocated at least one physical slot number, and acquiring a logical library ID which is stored in a partition information table included in the relevant magazine, and which is information for identifying a corresponding one of at least one logical library which is logically partitioned, and at least one logical slot number which is stored in the partition information table, and each of which indicates a corresponding number of at least one logical number included in the corresponding one of at least one logical library;

searching the logical library configuration information table for a logical library ID and at least one logical slot number, a value of the logical library ID and a value of each of the at least one logical slot number being matched with a value of the logical library ID having been acquired and a value of each of the at least one logical slot number having been acquired, respectively; and

setting at least one physical slot number which is allocated to the relevant magazine slot into which the relevant magazine has been loaded, into at least one physical slot number which is included in the logical library configuration information table, and which corresponds to the logical library ID and the at least one logical slot number having been searched for.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Further, it is noted that the inventor's intent is to retain all equivalents of the claimed invention even if the claims are amended during prosecution.

1. A library apparatus comprising:
a plurality of magazines, each magazine including at least one medium slot in each of which a removable storage medium is stored, and a magazine ID portion which indicates a magazine ID which is information for identifying itself;
at least one magazine slot, each magazine slot being allocated at least one physical slot number which, at a time when one of the magazines has been loaded into the each magazine slot, is allocated to the at least one medium slot of the relevant magazine on a one-to-one correspondence basis;
an ID reading unit configured to read a magazine ID which is indicated by the magazine ID portion of one of the magazines which has been loaded into one of the at least one magazine slot;
a logical library configuration information table including at least one logical library ID each being information for identifying one of at least one logical library which is logically partitioned, at least one logical slot number each indicating a number of a corresponding one of at least one logical slot included in each of the at least one logical library, the at least one physical slot number which is allocated to each of the at least one magazine slot, and which corresponds to the at least one logical slot number, the magazine ID which is indicated by the magazine ID portion provided in a certain one of the magazines, which is to be loaded in one of the at least one magazine slot, and magazine presence or absence information which indicates whether any one of the magazines is loaded, or not, for each of the at least one magazine slot; and
a logical library management unit configured to, when having detected an event in which one of the magazines has been loaded into one of the at least one magazine slot, update the magazine presence or absence information included in the logical library configuration information table, on the basis of information indicating the magazine slot into which the relevant magazine has been loaded, and the magazine ID which corresponds to the relevant magazine, and which has been read by the ID reading unit.

2. The library apparatus according to claim 1, wherein, when having detected an event in which one of the magazines has been unloaded from one of the at least one magazine slot, the logical library management unit updates the magazine presence or absence information included in the logical library configuration information table into information indicating that the relevant magazine does not exist in the magazine slot from which the relevant magazine has been unloaded, on the basis of information indicating the magazine slot from which the relevant magazine has been unloaded, and the magazine ID which corresponds to the relevant magazine, and which has been read by the ID reading unit.

3. A library apparatus comprising:
a plurality of magazines, each magazine including at least one medium slot in each of which a removable storage medium is stored, and a magazine ID portion which indicates a magazine ID which is information for identifying itself;
at least one magazine slot, each magazine slot being allocated at least one physical slot number which, at a time when one of the magazines has been loaded into the each magazine slot, is allocated to the at least one medium slot of the relevant magazine on a one-to-one correspondence basis;
an ID reading unit configured to read a magazine ID which is indicated by the magazine ID portion of one of the magazines which has been loaded into one of the at least one magazine slot;
a logical library configuration information table including at least one logical library ID each being information for identifying one of at least one logical library which is logically partitioned, at least one logical slot number each indicating a number of a corresponding one of at least one logical slot included in each of the at least one logical library, the at least one physical slot number which is allocated to each of the at least one magazine slot, and which corresponds to the at least one logical slot number, and the magazine ID which is indicated by the magazine ID portion provided in a certain one of the magazines, which is loaded in one of the at least one magazine slot; and
a logical library management unit configured to, when having detected an event in which one of the magazines has been loaded into one of the at least one magazine slot, update the at least one physical slot number of the logical library configuration information table into a number the same as the at least one physical slot number being allocated to the at least one medium slot of the relevant medium, on the basis of information indicating the magazine slot into which the relevant magazine has been loaded, and the magazine ID which corresponds to the relevant magazine, and which has been read by the ID reading unit.

4. The library apparatus according to claim 3, wherein, when having detected an event in which one of the magazines has been unloaded from one of the at least one magazine slot, the logical library management unit updates each of the at least one physical slot number which is included in the logical library configuration information table, and which corresponds to the relevant magazine, into information indicating that the relevant magazines does not in the magazine slot from which the relevant magazine has been unloaded, on the basis of information indicating the magazine slot from which the relevant magazine has been unloaded, and the magazine ID which corresponds to the relevant magazine, and which has been read by the ID reading unit.

5. A library apparatus comprising:
a plurality of magazines, each magazine including at least one medium slot in each of which a removable storage medium is stored, and a partition information unit which stores therein a logical library ID being information for identifying a certain one of at least one logical library which is logically partitioned, and at least one logical slot number each indicating a number of a corresponding one of at least one logical slot included in the certain one of at least one logical library;
at least one magazine slot, each magazine slot being allocated at least one physical slot number which, at a time when one of the magazines has been loaded into the each magazine slot, is allocated to the at least one medium slot of the relevant magazine on a one-to-one correspondence basis;
a partition information reading and writing unit configured to access the partition information unit of the one of the magazines which has been loaded into the one of the at least one magazine slot;
a logical library configuration information table including the at least one logical library ID, the at least one logical slot number, and the at least one physical slot number which is allocated to each of the at least one magazine slot, and which corresponds to the at least one logical slot number; and
a logical library management unit configured to, when having detected an event in which one of the magazines has been loaded into one of the magazine slots, update each of the at least one physical slot number included in the logical library configuration information table into a number the same as a corresponding one of the at least one physical slot number being allocated to the at least one medium slot of the relevant magazine, on the basis of the logical library ID and the at least one logical slot number, which correspond to the at least one medium slot of the relevant magazine, and which have been acquired by the partition information reading and writing unit.

6. The library apparatus according to claim 5, wherein, when having detected an event in which one of the magazines has been unloaded from one of the at least one magazine slot, the logical library management unit updates each of the at least one physical slot number included in the logical library configuration information table into information indicating that the relevant magazine does not exist in the relevant magazine slot, on the basis of the logical library ID and the at least one logical slot number, which correspond to the at least one medium slot of the relevant magazine, and which have been acquired by the partition information reading and writing unit.
